(19) United States
(12) Patent Application Publication
(10) Pub. No.: US 2024/0047104 A1
(43) Pub. Date: Feb. 8, 2024

(54) PERMANENT MAGNET AND DEVICE

(71) Applicants: KYUSHU INSTITUTE OF TECHNOLOGY, Kitakyushu-shi (JP); TOKIN Corporation, Sendai-shi (JP)

(72) Inventors: Masaaki TAKEZAWA, Kitakyushu-shi (JP); Hiroaki MACHIDA, Sendai-shi (JP); Teruhiko FUJIWARA, Sendai-shi (JP); Hirokazu MAKUTA, Sendai-shi (JP)

(21) Appl. No.: 18/354,532

(22) Filed: Jul. 18, 2023

(30) Foreign Application Priority Data
Aug. 2, 2022 (JP) 2022-123094

(51) Int. Cl. H01F 1/059; C22C 19/07; C22C 19/00; C22C 1/03; B22F 9/04; B22F 3/16; B22F 3/24

(52) U.S. Cl. CPC H01F 1/059; C22C 19/07; C22C 19/007; C22C 1/03; B22F 9/04; B22F 3/16; B22F 3/24; C22C 2202/02; B22F 2999/00; B22F 2998/10; B22F 2301/155; B22F 2201/10; B22F 2202/05; B22F 2201/20; B22F 2003/241; B22F 2003/248

(57) ABSTRACT

A permanent magnet having excellent magnetic properties and a device including such a permanent magnet are provided. A permanent magnet consists of a sintered compact having a composition consisting of R: 23 to 27 wt % (R is a sum total of rare-earth elements including at least Sm), Fe: 22 to 27 wt %, Mn: 0.3 to 2.5 wt %, Cu: 4.0 to 5.0 wt %, and a remainder consisting of Co and unavoidable impurities, in which the sintered compact contains a plurality of crystal grains and grain boundary phases, and a concentration of Cu in at least a part of the grain boundary phases is 45 at % or higher.

### CROSS REFERENCE TO RELATED APPLICATION

The present application claims priority to Japanese Patent Application No. 2022-123094 filed on Aug. 2, 2022. The entire contents of the above-listed application is hereby incorporated by reference for all purposes.

### TECHNICAL FIELD

The present disclosure relates to a permanent magnet and a device.

### BACKGROUND

As a type of a permanent magnet, a rare-earth cobalt permanent magnet such as a samarium-cobalt magnet has been known. Regarding rare-earth cobalt permanent magnets, studies regarding those that contain Fe, Cu, Zr or the like have been conducted from various aspects, for example, for improving their magnetic properties.

For example, Japanese Unexamined Patent Application Publication No. 2017-168827 discloses a permanent magnet that contains specific respective amounts of rare earth elements Fe, Cu, Co, Zr, Ti and Hf, and has a structure containing crystal grains consisting of a main phase containing a Th₂Zn₁₇-type crystalline phase, and crystal grain boundaries between the crystal grains, in which the average grain size of the crystal grains is 50 to 100 μm.

International Patent Publication No. WO2015/140829 discloses a specific permanent magnet containing specific respective amounts of rare earth elements Fe, Cu, Co, Zr, Ti and Hf, and has a cell phase containing a Th₂Zn₁₇-type crystalline phase and a Cu-rich phase having a Cu concentration higher than that of the cell phase, in which the average diameter of the cell phase is 220 nm or smaller.

Further, Japanese Unexamined Patent Application Publication No. 2020-188140 discloses a rare-earth cobalt permanent magnet containing specific respective amounts of rare earth elements R, Fe, Cu, Co and Zr, and has cell walls containing a Th₂Zn₁₇-type crystalline phase and a crystalline phase having an RCos-type structure surrounding the cell phase, in which the concentration of the rare earth elements in the cell walls is at least 25 at % higher than that of the rare earth elements in the cell phase.

### SUMMARY

An object of the present disclosure is to provide a permanent magnet having excellent magnetic properties, especially an excellent coercive force, and excellent squareness, and provide a device including such a permanent magnet.

A permanent magnet according to the present disclosure consists of a sintered compact having a composition consisting of R: 23 to 27 wt % (R is a sum total of rare-earth elements including at least Sm), Fe: 22 to 27 wt %, Mn: 0.3 to 2.5 wt %, Cu: 4.0 to 5.0 wt %, and a remainder consisting of Co and unavoidable impurities, in which the sintered compact contains a plurality of crystal grains and grain boundary phases, and a concentration of Cu in at least a part of the grain boundary phases is 45 at % or higher.

The above-described permanent magnet may further contain Zr: 1.7 to 2.5 wt %.

In any one of the above-described permanent magnets, the crystal grains may have a phase of a Th 2 Zni 7 -type structure and a phase of an RCos-type structure.

In any one of the above-described permanent magnets, an average grain size (A.G.) of the crystal grains may be 100 1.tm or larger.

In any one of the above-described permanent magnets, a coefficient of variation (C.V.) of grain sizes of the crystal grains may be 0.60 or smaller.

In any one of the above-described permanent magnets, a thickness t of the grain boundary phase may be 5 to 200 nm.

In any one of the above-described permanent magnets, when a reverse magnetic field is applied to the permanent magnet, a reverse magnetic domain may occur inside at least some of the crystal grains, and the reverse magnetic domain may propagate throughout the inside of the crystal grains.

A device according to the present disclosure includes any one of the above-described permanent magnets.

According to the present disclosure, a permanent magnet having excellent magnetic properties, especially an excellent coercive force, and excellent squareness, and a device including such a permanent magnet are provided.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic diagram showing an example of a cross section of a permanent magnet according to an embodiment;

FIG. 2 is an enlarged schematic diagram of a part A (a part of a crystal grain) shown in FIG. 1;

FIG. 3 is a schematic hysteresis curve of a permanent magnet for explaining physical quantities such as a squareness ratio;

FIG. 4 shows schematic diagrams for explaining a process through which a reverse magnetic domain occurs and propagates inside an ordinary permanent magnet;

FIG. 5 shows schematic diagrams for explaining a process through which a reverse magnetic domain occurs and propagates inside a permanent magnet according to an embodiment;

FIG. 6 shows schematic diagrams explaining a method for manufacturing a permanent magnet according to an embodiment;

FIG. 7 is a graph showing the composition of grain boundary phases of a permanent magnet according to an Example 2;

FIG. 8 is a graph showing the composition of grain boundary phases of a permanent magnet according to a Comparative Example 5; and

FIG. 9 is a graph showing a relationship between a demagnetization curve of a permanent magnet according to Example 1 and propagation of a reverse magnetic domain thereof.

### DETAILED DESCRIPTION

A permanent magnet and a device according to the present disclosure will be described hereinafter.

Note that the following descriptions and drawings have been simplified as appropriate for clarifying the explanation. Further, the scale of each component may be significantly different from one component to another in the drawings for the sake of explanation.

Further, a numerical range such as “n-m” or “n to m” (i.e., “from n to m”) includes the lower and upper limit values, unless otherwise specified.

### [Permanent Magnet]

A permanent magnet according to the present disclosure (hereinafter also referred to simply as the permanent magnet) consists of a sintered compact having a composition consisting of R: 23 to 27 wt % (R is a sum total of rare-earth elements including at least Sm), Fe: 22 to 27 wt %, Mn: 0.3 to 2.5 wt %, Cu: 4.0 to 5.0 wt %, and a remainder consisting of Co and unavoidable impurities, in which the sintered compact contains a plurality of crystal grains and grain boundary phases, and a concentration of Cu in at least a part of the grain boundary phases is 45 at % or higher.

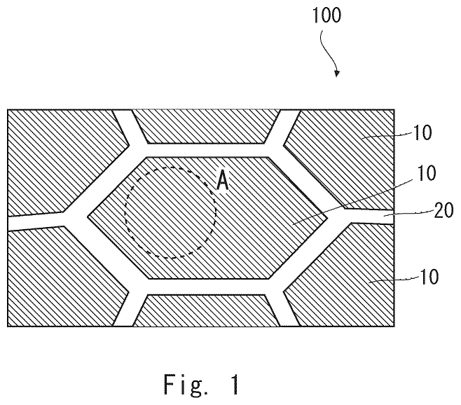

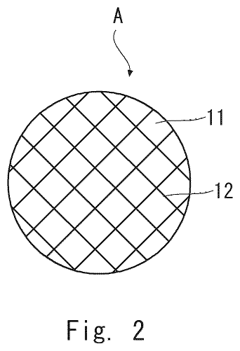

A metallographic structure of a permanent magnet according to this embodiment will be described with reference to FIGS. 1 and 2. FIG. 1 is a schematic diagram showing an example of a cross section of the permanent magnet, and FIG. 2 is an enlarged schematic diagram of a part A (a part of a crystal grain 10) shown in FIG. 1. As shown in the example shown in FIG. 1, the permanent magnet 100 contains a plurality of crystal grains 10 and grain boundary phases 20 present between the crystal grains 10. Further, as shown in the example shown in FIG. 2, each crystal grain 10 has a phase 11 having a Th₂Zn₁₇-type structure (hereinafter also referred to as the 2-17 phase) and a phase 12 having an RCos-type structure (hereinafter also referred to as the 1-5 phase), in which the 2-17 phase is the main phase (having a volume ratio of 50% or higher). Note that the crystal grain 10 may further have a crystal phase having a TbCu₇-type structure (hereinafter also referred to as the 1-7 phase) (not shown).

The phase having the Th₂Zn₁₇-type structure is a crystal structure having an R-3m-type space group. In the permanent magnet, in general, the Th part is occupied by a rare earth element and Zr, and the Zn part is occupied by Co, Cu, Fe and Zr. Further, in the phase 12 having the RCos-type structure, in general, the R part is occupied by a rare earth element and Zr, and the Co part is occupied by Co, Cu and Fe. Further, in the crystal phase having the TbCu₇-type structure, in general, the Tb part is occupied by a rare earth element and Zr, and the Cu part is occupied by Co, Cu and Fe. The crystal structure can be determined by an X-ray diffraction method.

The permanent magnet contains 0.3 to 2.5 wt % of Mn, and by manufacturing it by a manufacturing method described later, Cu can be concentrated to 45 at % or higher in at least a part of the grain boundary phase 20. As a result, it is possible to obtain a permanent magnet having excellent magnetic properties, especially a high squareness ratio.

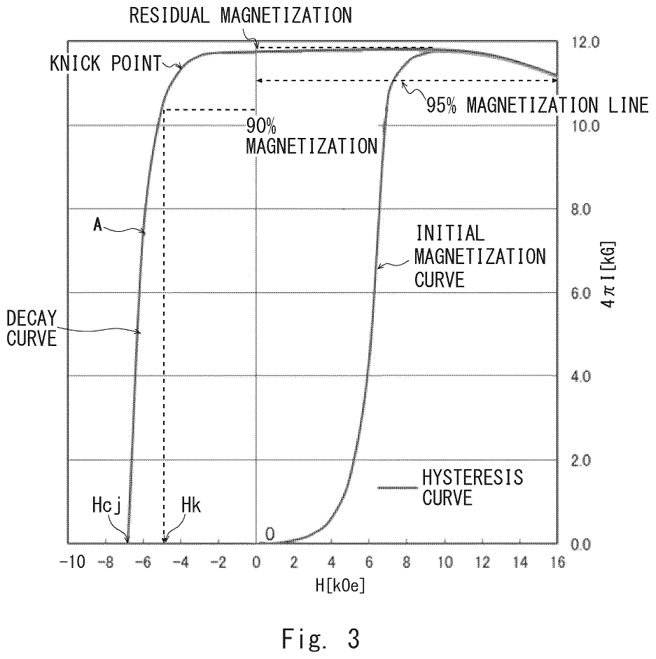

The squareness ratio and the like will be described with reference to FIG. 3. FIG. 3 shows schematic hysteresis curves of a permanent magnet, and shows a first quadrant and a second quadrant (demagnetization curve). The vertical axis indicates magnetization (magnetic polarization) and the horizontal axis indicates strengths of magnetic fields. A positive value on the horizontal axis indicates the strength of a magnetic field applied in a direction for magnetizing the permanent magnet, and a negative value indicates the strength of a magnetic field applied in a direction for demagnetizing the permanent magnet.

When a magnetic field is applied to the permanent magnet in the positive direction, magnetic polarization occurs according to the initial magnetization curve and reaches saturated magnetization. Next, when a magnetic field is applied to the permanent magnet in the saturated-magnetization state in the negative direction, it rapidly demagnetizes after reaching the knick point. The strength of the magnetic field when the magnetic polarization becomes zero is the intrinsic coercive force (Hcj).

In this embodiment, the magnetic field at 90% magnetization of the residual magnetization is represented as Hk, and a ratio (Hk/Hcj) thereof to the intrinsic coercive force Hcj is defined as the squareness ratio. Regarding the permanent magnet according to the present disclosure, it is possible to achieve the squared ratio of 65% or higher, and preferably 70% or higher.

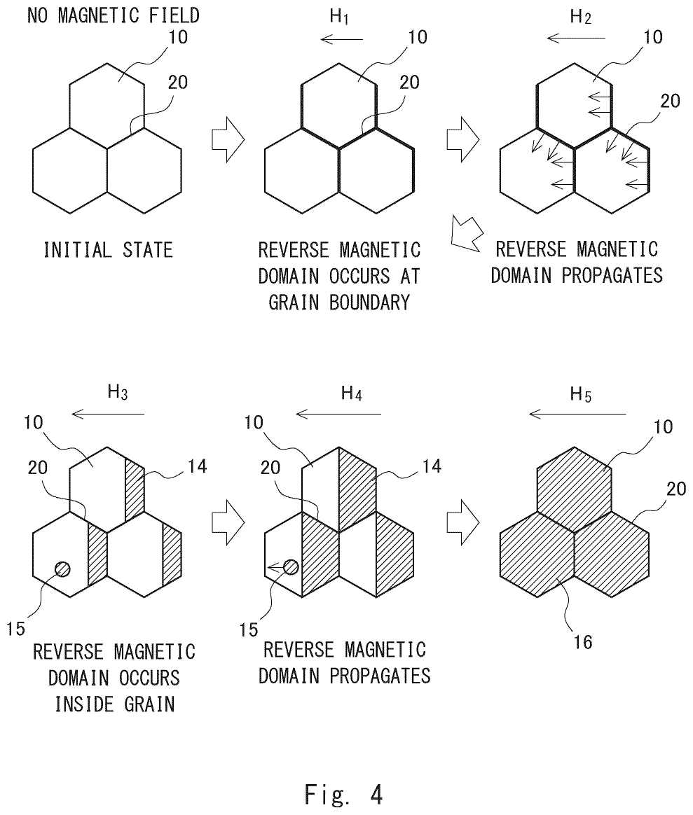

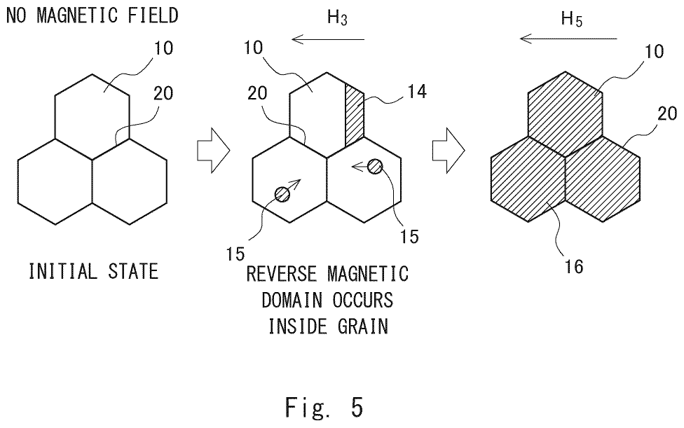

Next, a mechanism by which a reverse magnetic domain of the permanent magnet according to this embodiment occurs will be described with reference to FIGS. 4 and 5. FIG. 4 shows a schematic diagram for explaining a process through which a reverse magnetic domain occurs and propagates inside an ordinary permanent magnet, and FIG. 5 shows a schematic diagram for explaining a process through which a reverse magnetic domain occurs and propagates inside the permanent magnet according to this embodiment.

As shown in FIG. 4, no reverse magnetic domain is occurring in the initial state (a state in which no reverse magnetic field is applied) in the demagnetization curve of the permanent magnet. When a H₁ reverse magnetic field is applied to the permanent magnet, in general, a reverse magnetic domain first occurs at or near the interface (grain boundary) between the crystal grain 10 and the grain boundary phase 20. After that, when the reverse magnetic field is strengthened, the reverse magnetic domain propagates from the grain boundary phase 20 into the crystal grain 10 (a reverse magnetic field H₂). When the reverse magnetic field is further strengthened, the reverse magnetic domain 14 spreads inside the crystal grain 10, and another reverse magnetic domain 15 occurs inside the crystal grain 10 (a reverse magnetic field H₃) . Then, when the reverse magnetic field is further strengthened (H₄ to H₅), the reverse magnetic domain 14 inside the crystal grain 10 spreads further, and the reverse magnetic domain 15 generated inside the crystal grain 10 propagates inside the crystal grain 10. Further, a reverse magnetic domain 16 spreads throughout the crystal grain 10, and the magnetic reversal of the permanent magnet ends. Note that H₁ to H₅ in FIGS. 4 and 5 have negative values, and it is assumed that the magnitudes of the absolute values of them are in the order of H₁, H₂, . . . , H₅.

It is presumed that, in the permanent magnet according to this embodiment, since the concentration of Cu inside the grain boundary phases 20 is a high and the un-magnetization is remarkable, the reverse magnetic domain is less likely to occur at the grain boundaries. Therefore, it is presumed the main mechanism by which the reverse magnetic domain occurs and propagates is as follows, that is, when a certain level of a reverse magnetic field (e.g., H₃) is applied to the permanent magnet, a reverse magnetic domain 15 first occurs inside the crystal grain 10 and this reverse magnetic domain 15 propagates throughout inside the crystal grain. It is also presumed, as a result, in the demagnetization factor (the second quadrant) in FIG. 3, the inclination of the curve in a small region of the reverse magnetic field becomes smaller than that at the knick point, so that the squareness is greatly improved.

Next, the metallographic structure, such as the composition, of the permanent magnet according to this embodiment will be described.

In this embodiment, the term “rare-earth element R” is a general term for Sc, Y, and lanthanoids (elements having atomic numbers 57 to 71), and includes at least Sm as the rare-earth element R. As the rare-earth element R, only Sm may be used, or a combination of Sm and at least one type of other rare-earth elements may be used. As the other rare-earth elements, Pr, Nd, Ce and La are preferred in view of the magnetic properties. Further, in view of the magnetic properties, the content of Sm is preferably 80 wt % or larger, more preferably 90 wt % or larger, and still more preferably 95 wt % or larger based on the total amount of the rare-earth elements R.

The permanent magnet contains 23 to 27 wt % of rare-earth elements R. By having the permanent magnet contain the rare-earth elements in the aforementioned ratio, it is possible to obtain a permanent magnet having high magnetic anisotropy and a high coercive force.

The permanent magnet contains 22 to 27 wt % of Fe. The saturated magnetization is improved by having the permanent magnet contain 22 wt % of Fe or larger. Further, by adjusting the content of Fe to 27 wt % or smaller, the permanent magnet has a high coercive force.

This permanent magnet contains 4.0 to 5.0 wt % Cu. By having the permanent magnet contain 4.0 wt % of Cu or larger, it is possible to increase the concentration of Cu in the grain boundary phase to 45 at % or higher, and thereby to make the permanent magnet have a high coercive force. Further, by adjusting the content of Cu to 5.0 wt % or smaller, the deterioration of the magnetization is suppressed.

This permanent magnet contains 0.3 to 2.5 wt % Mn. The concentration of Cu in the grain boundary phase can be increased by having the permanent magnet contain 0.3 wt % Mn or higher. Further, by having the permanent magnet contain Mn in the above-described range, crystal structures containing crystal grains having relatively large and uniform grain sizes can be easily obtained, so that the squareness ratio is improved. However, when the content of Mn exceeds 2.5 wt %, the grain sizes tend to become smaller instead of becoming larger.

It is presumed that, by having the permanent magnet contain 0.3 wt % of Mn or larger, the melting point is lowered, so that the liquid phase appears more during the sintering and a concentration distribution of Cu and the like is formed. Further, it is presumed that since the liquid phase appears a lot, the grain size of crystal grains increases. Further, it is presumed that Mn also contributes to the non-magnetization of the grain boundary phase, so that the occurrences of reverse magnetic domains in the grain boundary phase are suppressed.

Preferably, the permanent magnet further contains 1.7 to 2.5 wt % of Zr. Further, by having the permanent magnet contain 1.7 to 2.5% of Zr, it is possible to increase the maximum energy product (BH)m of the permanent magnet, which is the maximum magnetostatic energy that the magnet can hold.

Further, the remainder of the permanent magnet consists of Co and unavoidable impurities. By having the permanent magnet contain Co, the thermal stability of the permanent magnet is improved. However, when the content of Co is too large, the content of Fe is relatively reduced.

The unavoidable impurities are elements that are unavoidably mixed in the permanent magnet from the raw material or during the manufacturing process. Examples of unavoidable impurities include, but are not limited to, C, N, P, S, Al, Ti, Cr, Ni, Hf, Sn and W. In the permanent magnet, the total ratio of unavoidable impurities is preferably 5 wt % or lower, more preferably 1 wt % or lower, still more preferably 0.1 wt % or lower based on the total amount of the permanent magnet.

The content ratio of each of the elements contained in a local area (i.e., in a small area) of the permanent magnet can be measured, for example, by using energy dispersive X-ray spectroscopy (EDX: Energy dispersive X-ray spectrometry).

The permanent magnet according to this embodiment preferably has a metallographic structure in which the average grain size (A.G.) of crystal grains is 100 μm or larger. Further, a coefficient of variation (C.V.) of grain sizes of the crystal grains of the permanent magnet according to this embodiment may be 0.6 or smaller.

A method for measuring the average grain size (A.G.) and the coefficient of variation (C.V.) of crystal grains of the permanent magnet will be described.

Firstly, a permanent magnet to be measured is polished with water-resistant abrasive paper. Regarding the water-resistant abrasive paper, coarse abrasive paper is used at first, and then it is repeatedly replaced by finer one. After being polished by a plurality of pieces of water-resistant abrasive paper, the permanent magnet is mirror-polished by using a buffing machine or the like. Etching of the mirror-polished permanent magnet is carried out by impregnating the permanent magnet with an acid solvent (or submerging the permanent magnet in an acid solvent). In this process, since the grain boundaries 20 are corroded faster than the crystal grains 10 are, the grain boundaries appear clearly, thus making it possible to observe each crystal grain clearly. Next, the permanent magnet is washed with pure water or the like and then dried. It is possible to observe crystal grains by observing the processed surface of the obtained permanent magnet with an optical microscope.

In this embodiment, the maximum Feret diameter (or the Feret length) of crystal grains is used as the grain size of the crystal grains. The Feret diameter is defined as a distance between two parallel lines located on both sides of a crystal grain, and in the present disclosure, the maximum value of such Feret diameters is used as the grain size of crystal grains. Note that it is possible to measure the grain size of crystal grains more accurately by using image processing software.

The grain sizes of crystal grains contained in a measurement area of 500 μm×500 μm are obtained (i.e., measured), and the average crystal grain size (A.G.) and the coefficient of variation (C.V.) of the crystal grains are calculated from these values.

The average crystal grain size (A.G.) may be 100 μm or larger, and preferably 120 μm or larger. Further, although there is no particular limit on the upper limit of the average crystal grain size, the average crystal grain size is typically 1,000 μm or smaller, and preferably 500 μm or smaller.

Further, the coefficient of variation (C.V.) may be 0.6 or smaller, and preferably 0.5 or smaller.

Further, the thickness t of the grain boundary phase of the permanent magnet is preferably 5 to 200 nm. The thickness of the grain boundary phase may be obtained from the average distance between crystal grains in the above-described measurement of the grain size of crystal grains. However, in this embodiment, since the grain boundary phase having a thickness of 100 nm or smaller is formed, the range in which the concentration of Cu is 10 at % or higher in the above-described energy dispersive X-ray spectroscopy is used as the thickness of grain boundary phase.

### <Method for Manufacturing Permanent Magnet>

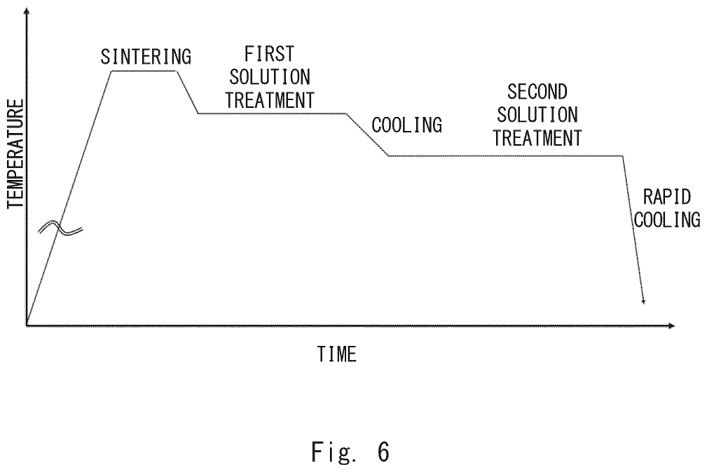

The Cu concentration of the grain boundary phase of the above-described permanent magnet can be increased by, for example, but not limited to, adjusting the conditions of the heat treatment. An example of such a method is a method in which the solution treatment step after the sintering is carried out in two stages (see FIG. 6). In the example shown in FIG. 6, in the first solution treatment, the diffusion of the solid phase is accelerated in most of crystal grains, the liquid phase is made to remain in the grain boundary phase. Next, by controlling the temperature decreasing rate, the elements other than Cu are discharged from the liquid phase to the solid phase, and Cu is thereby concentrated in the liquid phase. The temperature decreasing rate is preferably 0.1 to 5° C./min. Next, in the second solution, the liquid phase is made to completely disappear and the homogenization of the composition is made to proceed by the diffusion of the solid phase. It is possible to increase the concentration of Cu in the grain boundary phase by the above-described manufacturing method. Each of the steps of the manufacturing method will be described hereinafter in a more detailed manner.

Firstly, an alloy having a composition consisting of R: 23 to 27 wt % (R is a sum total of rare-earth elements including at least Sm), Fe: 22 to 27 wt %, Mn: 0.3 to 2.5 wt %, Cu: 4.0 to 5.0 wt %, and the remainder consisting of Co and unavoidable impurities is prepared. Regarding the method for preparing the alloy, the alloy may be prepared by obtaining a commercially available alloy having a desired composition, or may be prepared by blending aforementioned elements so that the blend has a desired composition.

A specific example of the blending of the elements will be described hereinafter by using an example.

Firstly, a desired rare-earth element(s), each of metal elements of Fe, Mn and Co, and a base alloy are prepared as raw materials. Note that it is preferable to select, as the base alloy, one having a composition having a low eutectic temperature because, by doing so, it is easy to make the composition of the obtained alloy homogeneous. In the present disclosure, FeZr or CuZr is preferably selected and used as the base alloy. As an example of FeZr, one containing about 20% of Fe and about 80% of Zr is suitable. Further, as an example of CuZr, one containing about 50% of Cu and 50% of Zr is suitable.

It is possible to obtain a homogeneous alloy by blending the aforementioned raw materials so that the blend has a desired composition, putting the blend in a crucible made of alumina or the like, and dissolving the blend in a vacuum of 1×10⁻² torr or lower, or in an inert-gas atmosphere by using a high-frequency melting furnace. Further, the present disclosure may include a step of casting the molten alloy by using a mold and thereby obtaining an alloy ingot. Alternatively, as a different method, a flaky alloy having a thickness of about 1 mm may be manufactured by dropping the molten alloy onto a copper roll (a strip casting method).

Further, in the case where the alloy ingot is obtained by the above-described casting, the alloy ingot may be heat-treated at a solution-treatment temperature for 1 to 20 hours. Note that the solution-treatment temperature for the alloy ingot may be adjusted as appropriate according to the composition and the like of the alloy.

Next, the alloy is pulverized into a powder. The method for pulverizing the alloy is not limited to any particular method, and may be selected as appropriate from known methods. As an example, the alloy ingot or the flake alloy is first coarsely pulverized to a size of about 100 to 500 μm by a known pulverizing machine, and then finely pulverized by a ball mill or a jet mill. Although the average grain size of the powder is not limited to any particular size, the alloy ingot or the flake alloy may be pulverized into a powder of which 60 mass % or larger has an average grain size of no smaller than 1μm and no larger than 10 μm, preferably about 8 μm or smaller, and more preferably 6 μm or smaller so that the sintering time of the sintering step (which will be described later) can be shortened and a homogeneous permanent magnet can be manufactured.

Next, the obtained powder is pressure-molded, so that a molded body having a desired shape is obtained. In the manufacturing method according to the present disclosure, the obtained powder is preferably pressure-molded in a constant magnetic field in order to align the orientation of crystals of the powder and thereby to improve the magnetic properties thereof. There is no particular restriction on the relation between the direction of the magnetic field and the pressing direction, and they may be selected as appropriate according to the shape and the like of the product. For example, when a ring magnet or a thin plate-like magnet is manufactured, it is possible to use parallel magnetic-field pressing in which a magnetic field is applied in a direction parallel to the pressing direction. On the other hand, in order to achieve excellent magnetic properties, it is preferable to use right-angle magnetic-field pressing in which a magnetic field is applied at a right angle with respect to the pressing direction.

The magnitude of the magnetic field is not limited to any particular value, and the magnetic field may be, for example, a magnetic field of 15 kOe or weaker, or a magnetic field of 15 kOe or larger depending on the use and the like of the product. However, in order to achieve excellent magnetic properties, it is preferable to perform the pressure-molding in a magnetic field of 15 kOe or larger. Further, the pressure in the pressure molding may be adjusted as appropriate according to the size, the shape, and the like of the product. As an example, the pressure may be 0.5 to 2.0 ton/cm². That is, in the method for manufacturing the permanent magnet according to the present disclosure, in order to improve the magnetic properties, it is particularly preferable to pressure-mold the powder in a magnetic field of 15 kOe or larger at a pressure of 0.5 to 2.0 ton/cm² or smaller which is applied perpendicularly to the magnetic field.

Next, the molded body is heated, so that a sintered compact is obtained. In this manufacturing method according to the present disclosure, the conditions for the sintering can be arbitrarily determined as long as the obtained sintered body is sufficiently densified. For example, known conditions may be used. In order to densify the sintered compact, the sintering temperature is preferably 1,170 to 1,215° C., and more preferably 1,180 to 1,205° C. By adjusting the temperature to 1,215° C. or lower, the rare-earth elements, particularly Sm, are prevented from evaporating, and hence a permanent magnet having excellent magnetic properties can be manufactured. Further, in the present disclosure, since the melting point tends to decrease because of the presence of Mn, the sintering can be sufficiently performed at 1,215° C. or lower.

Regarding the temperature-increasing conditions during the sintering step, in order to remove the adsorptive gas contained in the molded body, it is preferable to start vacuuming at a room temperature and increase the temperature at a rate of 1 to 10° C./min. In the temperature-increasing process, a hydrogen atmosphere may be used instead of performing the vacuuming. Even in this case, it is preferable to switch the hydrogen atmosphere to the vacuum atmosphere in a temperature range of 1,150° C. or lower.

The sintering time is preferably 20 to 210 minutes, and more preferably to 150 minutes in order to sufficiently densify the sintered compact while preventing Sm from evaporating. Further, in order to prevent the oxidation, the above-described sintering step is preferably performed in a vacuum of 1,000 Pa or lower or in an inert-gas atmosphere. Further, in order to increase the density of the sintered compact, more preferably, the sintering step is performed in a vacuum of 100 Pa or lower.

After the sintering, the temperature is decreased to the solution-treatment temperature and the solution treatment process is carried out. In order to make grain sizes of crystal gains uniform (to suppress the increase in the coefficient of variation (C.V.)), the temperature decreasing rate up to the solution-treatment temperature is preferably 0.01 to 3° C./min.

The solution treatment process is a step for forming a 1-7 phase (a TbCu 7 -type structure), which is a precursor for separation into a 2-17 phase and a 1-5 phase. In this manufacturing method, the solution treatment is carried out in two stages. In order to make the liquid phase remain in the grain boundary phase, the temperature of the first solution treatment is preferably 1,130 to 1,180° C., and more preferably 1,140 to 1,170° C. Further, in view of the homogenization of the elements other than Cu, the time of the first solution treatment is preferably 5 to 150 hours, and more preferably 10 to 100 hours. Next, by controlling the temperature decreasing rate, the elements other than Cu are discharged from the liquid phase to the solid phase, and Cu is thereby concentrated in the liquid phase. The temperature decreasing rate is preferably 0.1 to 5° C./min. In the second solution, the liquid phase is made to completely disappear, and the homogenization of the composition is made to proceed by the diffusion of the solid phase. The temperature of the second solution is preferably 1,110 to 1,165° C., and more preferably 1,120 to 1,160° C. Further, in view of the homogenization, the time of the second solution is preferably 5 to 150 hours, and more preferably 10 to 100 hours. The solution treatment is preferably performed in a vacuum of 1,000 Pa or lower, or in an inert atmosphere.

After the solution treatment process, it is preferable to rapidly cool the molded body to 600° C. or lower. The cooling rate of the rapid cooling is preferably 80° C./min or higher. The crystal structure of the 1-7 phase is maintained by performing the rapid cooling. Meanwhile, though depending on the shape of the molded body, the upper limit of the cooling rate is preferably, for example, 250° C./min or lower.

Next, after the rapid cooling step, the molded body is subjected to an aging process, so that a 2-17 phase and a 1-5 phase are formed. Although the aging temperature is not limited to any particular temperature, in order to obtain a permanent magnet containing the 2-17 phase as the main phase, and homogeneously (or uniformly) containing the 2-17 phase and the 1-5 phase, it is preferable to use a method in which the molded body is held at a temperature of 700 to 900° C. for 2 to 20 hours, and after that the cooling rate is set to 2° C./min or lower until the molded body is cooled to 400° C. or lower. By holding the molded body at the temperature of 700° C. to 900° C. for 2 to 20 hours, the 2-17 phase and the 1-5 phase can be homogeneously formed. In particular, the aging treatment is preferably performed in a temperature range of 800 to 850° C. Further, in order to obtain satisfactory magnetic properties, the cooling rate is preferably adjusted to 2° C./min or lower, and more preferably 0.5° C./min or lower.

By the above-described manufacturing method, it is possible to obtain a permanent magnet containing a plurality of crystal grains and grain boundary phases, in which the concentration of Cu in at least a part of the grain boundary phases is 45 at % or higher. Further, according to the above-described manufacturing method, it is possible to easily manufacture a permanent magnet of which the average grain size (A.G.) of the crystal grains is 100 μm or larger, and the coefficient of variation (C.V.) of grain sizes of the crystal grains is 0.60 or smaller.

### [Device]

The present disclosure can also provide a device including the above-described permanent magnet. Examples of such a device include clocks (watches), electric motors, various instruments, communication apparatuses, computer terminals, speakers, video discs, and sensors. Further, since the permanent magnet according to the present disclosure has a high residual magnetic flux density, a high coercive force, and a high squareness ratio as described above, it can be suitably applied to, among others, a variable magnetic-field motor, so that it is possible to obtain a variable magnetic-field motor capable of achieving high efficiency over a wide speed range from a low speed to a high speed.

### EXAMPLE

The present disclosure will be described hereinafter in a concrete manner by using examples and comparative examples. Note that the present disclosure is not limited by the descriptions of examples and the like below.

### Examples 1 to 3

Base alloys each containing 20% of Fe and 80% of Zr, and various raw materials were prepared (i.e., mixed) so that compositions of Examples 1 to 3 shown in the Table 1 were obtained. Then, they were dissolved by a high-frequency melting furnace, and the melt was cast into alloy ingots.

Each of the obtained base alloys was coarsely pulverized in an inert gas so that the average size became about 100 to 500 μm, and then finely pulverized into a powder in an inert gas by using a ball mill so that the average size became about 6 μm.

Molded bodies were obtained by pressing the powders in a magnetic field of 15 kOe with a pressure of 1 ton/cm² .

Each of the molded body was sintered at 1,200° C. for 80 minutes in a vacuum lower than 1,000 Pa, and then the first solution treatment process was performed at 1,150° C. for 20 hours. Further, the molded body was slowly cooled at 1.0° C./min, and the second solution treatment process was performed at 1,135° C. for 50 hours. Next, the molded body was rapidly cooled from 1,000 to 600° C. at a cooling rate of 80° C./min. After the rapid cooling, the molded body was kept at 850° C. for 12 hours, and then was subjected to an aging process under a condition that the molded body was slowly cooled to 350° C. at a cooling rate of 0.5° C./min. Through these processes, a permanent magnet was obtained.

### Comparative Examples 1 and 2

Permanent magnets were obtained in the same manner as in the Examples 1 to 3 except that the compositions were changed to those for Comparative Examples 1 and 2 shown in Table 1.

### Examples 4 to 6

Permanent magnets were obtained in the same manner as in the Examples 1 to 3 except that the compositions were changed to those for Examples 4 to 6 shown in Table 2, and the temperature decreasing rates in the slow cooling from the first solution treatment process to the second solution treatment process were changed to those for Examples 4 to 6 shown in Table 2.

### Comparative Example 3 to 4

Permanent magnets were obtained in the same manner as in the Examples 1 to 3 except that the compositions were changed to those for Comparative Examples 3 and 4 shown in Table 2, and the temperature decreasing rates in the slow cooling from the first solution treatment process to the second solution treatment process were changed to those for Comparative Examples 3 and 4 shown in Table 2.

### Comparative Example 5

A permanent magnet according to Comparative Example 5 was obtained in the same manner as in the Example 1 except that Mn was not added.

### [Evaluation]

### <Measurement of Squareness>

Magnetic properties of the obtained permanent magnets were measured by using a B-H tracer, and for each of them, the squareness ratio, which is expressed as the ratio (Hk/Hcj) of the magnetic field (Hk) to the coercive force (Hcj) when the magnetization reaches 90% of the residual magnetization, was obtained. Tables 1 to 2 show the results.

### <Measurements of Cu Concentration in Grain Boundary Phase>

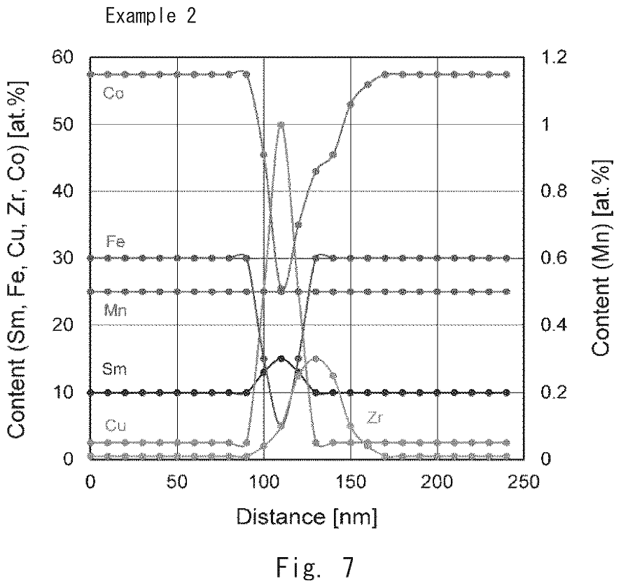

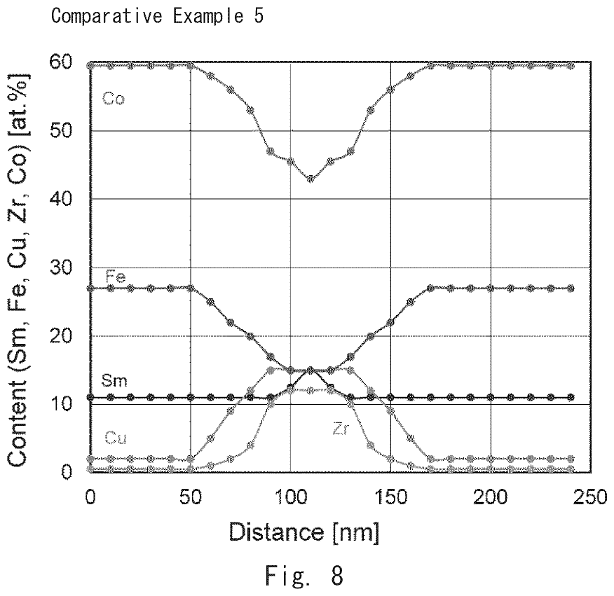

Each of the obtained permanent magnets was cut, and for each of them, a cross section containing a grain boundary phase (i.e., a cross section on which a grain boundary phase was seen) was measured (i.e., observed) by using an energy dispersive X-ray spectroscope. The maximum concentrations of Cu are shown in Tables 1 and 2. Further, FIGS. 7 and 8 show the measurement results of the Example 2 and the Comparative Example 5.

<Mechanism by which Reverse Magnetic Domain Occurs>

For each of the obtained permanent magnets, the magnetic domain was observed by using a Kerr-effect microscope while applying a magnetic field, and the main mechanism by which the reverse magnetic domain occurred was determined. The results are shown in Tables 1 and 2.

TABLE 1
(When amount of Mn is changed)

| | | | | | | | Thickness | Mechanism of |
|---|---|---|---|---|---|---|---|---|
| | | Slow | | | Average | Coefficient of | of Grain | Occurrence |
| | | Cooling | Amount of | | Crystal Grain | Variation | Boundary | of Reverse |
| | | Rate | Cu | Hk/Hej | Size | (C.V.) of | Phase | Magnetic |
| | Composition | [° C./min] | [%] | [%] | [μm] | Crystal Grains | [nm] | Domain |
| Example 1 | Sm_{27.0}Fe [symbol] Cu_{4.00}Zr [symbol] Mn [symbol] Co [symbol] | 1.0 | 45.5 | 70 | 130 | 0.45 | 75 | Occur from |
| | | | | | | | | inside of |
| | | | | | | | | Crystal Grain |
| Example 2 | Sm_{27.0}Fe [symbol] Cu [symbol] Zr [symbol] Mn [symbol] Co [symbol] | 1.0 | 50.0 | 73 | 145 | 0.54 | 25 | Occur from |
| | | | | | | | | inside of |
| | | | | | | | | Crystal Grain |
| Example 3 | Sm [symbol] Fe [symbol] Cu_{4.00}Zr [symbol] Mn [symbol] Co [symbol] | 1.0 | 47.5 | 65 | 105 | 0.57 | 180 | Occur from |
| | | | | | | | | inside of |
| | | | | | | | | Crystal Grain |
| Comparative | Sm [symbol] Fe [symbol] Cu_{4.00}Zr [symbol] Mn [symbol] Co [symbol] | 1.0 | 44.5 | 64 | 95 | 0.62 | 2 [symbol] 5 | Occur from |
| Example 1 | | | | | | | | Crystal Grain |
| | | | | | | | | Boundary |
| Comparative | Sm_{27.0}Fe [symbol] Cu [symbol] Zr [symbol] Mn [symbol] Co [symbol] | 1.0 | 40.0 | 62 | 95 | 0.65 | 205 | Occur from |
| Example 2 | | | | | | | | Crystal Grain |
| | | | | | | | | Boundary |

[symbol]

indicates data missing or illegible when filed

TABLE 2
(When slow cooling rate is changed)

| | | | | | | | Thickness | Mechanism of |
|---|---|---|---|---|---|---|---|---|
| | | Slow | | | Average | Coefficient of | of Grain | Occurrence |
| | | Cooling | Amount of | | Crystal Grain | Variation | Boundary | of Reverse |
| | | Rate | Cu | Hk/Hej | Size | (C.V.) of | Phase | Magnetic |
| | Composition | [° C./min] | [%] | [%] | [μm] | Crystal Grains | [nm] | Domain |
| Example 4 | Sm_{23.0}Fe [symbol] Cu [symbol] Zr [symbol] Mn [symbol] Co [symbol] | 0.10 | 46.5 | 70 | 150 | 0.58 | [symbol] 5 | Occur from |
| | | | | | | | | inside of |
| | | | | | | | | Crystal Grain |
| Example 5 | Sm_{23.0}Fe [symbol] Cu [symbol] Zr [symbol] Mn [symbol] Co [symbol] | 1.0 | 49.0 | 71 | 125 | 0.37 | 40 | Occur from |
| | | | | | | | | inside of |
| | | | | | | | | Crystal Grain |
| Example 6 | Sm_{23.0}Fe_{22.0}Cu_{5.00}Zr [symbol] Mn [symbol] Co [symbol] | 5.0 | 48.0 | 66 | 100 | 0.33 | 200 | Occur from |
| | | | | | | | | inside of |
| | | | | | | | | Crystal Grain |
| Comparative | Sm_{23.0}Fe_{22.0}Cu_{5.00}Zr [symbol] Mn [symbol] Co [symbol] | 0.01 | 44.0 | 63 | 90 | 0.61 | 2 [symbol] 0 | Occur from |
| Example 3 | | | | | | | | Crystal Grain |
| | | | | | | | | Boundary |
| Comparative | Sm_{23.0}Fe_{22.0}Cu_{5.00}Zr [symbol] Mn [symbol] Co [symbol] | 10 | 35.0 | 62 | 80 | 0.62 | 205 | Occur from |
| Example 4 | | | | | | | | Crystal Grain |
| | | | | | | | | Boundary |

[symbol]

indicates data missing or illegible when filed

As shown in FIGS. 7 and 8, the concentration of Cu in the grain boundary phase was observed in both the Example 2 and the Comparative Example 5, but the concentration of Cu was easily increased as the permanent magnet contains to 2.5 wt % of Mn as in the case of the Example 2. As a result, in the Example 2, a part in which the concentration of Cu in the grain boundary phase was 45 at % or higher was observed. Similarly, in each of the Examples 1 and 3 to 6, a part in which the concentration of Cu in the grain boundary phase was 45 at % or higher was observed.

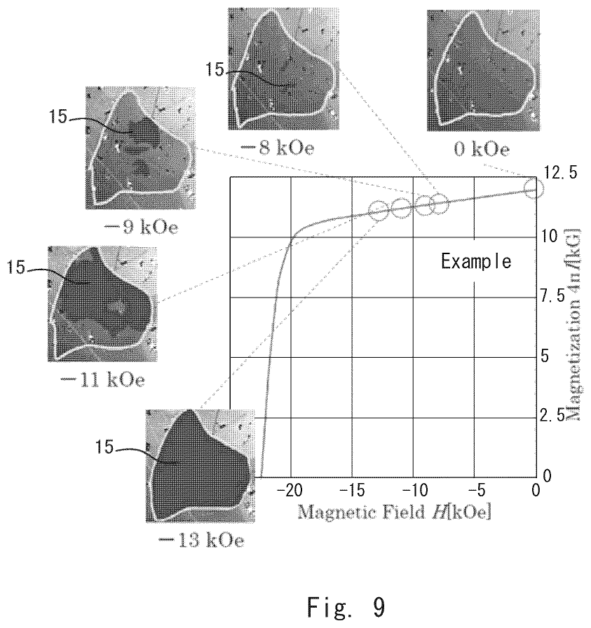

FIG. 9 is a graph showing a relationship between a demagnetization curve of the permanent magnet according to the Example 1 and propagation of a reverse magnetic domain thereof. In FIG. 9, the graph is for one crystal grain 10. In this crystal grain 10, no reverse magnetic domain 15 was observed when the reverse magnetic field was between 0 and −8 kOe, and a reverse magnetic domain was observed in the crystal grain for the first time when the reverse magnetic field was −8 kOe. Further, the magnetic reversal was completed when the reverse magnetic field was −13 kOe. As described above, it is presumed that the permanent magnet according to the present disclosure requires a strong reverse magnetic field from the occurrence of a reverse magnetic domain to the completion of the magnetic reversal, and as a result, in the demagnetization curve, the inclination of the curve in a small region of the reverse magnetic field becomes smaller than that at the knick point, so that the squareness is greatly improved. Similar results were also obtained in the other examples.

As shown in Tables 1 and 2, it was confirmed that each of the permanent magnets according to the Examples 1 to 6 contained a plurality of crystal grains and grain boundary phases, and the concentration of Cu in at least a part of the grain boundary phases was 45 at % or higher in each of them. It was confirmed that, in each of the permanent magnets according to the Examples 1 to 6, a reverse magnetic domain occurred inside the crystal grain, and the squareness ratio (Hk/Hcj) was 65% or higher.

Although the present disclosure has been described with the above-described embodiments, the present disclosure is not limited to the configurations of the above-described embodiments. That is, needless to say, the scope of the present disclosure includes various modifications, corrections, and combinations that can be made by those skilled in the art without departing from the scope and spirit of the disclosure specified by the claims of the present application.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

1. A permanent magnet consisting of a sintered compact having a composition consisting of R: 23 to 27 wt % (R is a sum total of rare-earth elements including at least Sm), Fe: 22 to 27 wt %, Mn: 0.3 to 2.5 wt %, Cu: 4.0 to 5.0 wt %, and a remainder consisting of Co and unavoidable impurities, wherein
the sintered compact contains a plurality of crystal grains and grain boundary phases, and a concentration of Cu in at least a part of the grain boundary phases is 45 at % or higher.

2. The permanent magnet according to claim 1, further containing Zr: 1.7 to 2.5 wt %.

3. The permanent magnet according to claim 1, wherein the crystal grains have a phase of a Th₂Zn₁₇-type structure and a phase of an RCos-type structure.

4. The permanent magnet according to claim 1, wherein an average grain size (A.G.) of the crystal grains is 100 μm or larger.

5. The permanent magnet according to claim 4, wherein a coefficient of variation (C.V.) of grain sizes of the crystal grains is 0.60 or smaller.

6. The permanent magnet according to claim 1, wherein a thickness t of the grain boundary phase is 5 to 200 nm.

7. The permanent magnet according to claim 1, wherein when a reverse magnetic field is applied to the permanent magnet, a reverse magnetic domain occurs inside at least some of the crystal grains, and the reverse magnetic domain propagates throughout the inside of the crystal grains.

8. A device including a permanent magnet according to claim 1.
